(19) United States
(12) Patent Application Publication
(10) Pub. No.: US 2010/0098800 A1
(43) Pub. Date: Apr. 22, 2010

(54) MOULD DEVICE FOR FORMING OBJECTS MADE OF PLASTICS

(75) Inventor: Davide Penazzi, Imola (IT)

Correspondence Address: LAUBSCHER & LAUBSCHER, P.C., 1160 SPA ROAD, SUITE 2B, ANNAPOLIS, MD, 21403, US

(73) Assignee: SACMI COOPERATIVA MECCANICI IMOLA SOCIETA' COOPERA, IMOLA (BO)

(21) Appl. No.: 12/526,174

(22) PCT Filed: Feb. 15, 2008
(86) PCT No.: PCT/IB08/00348

§ 371 Date: Nov. 3, 2009

(30) Foreign Application Priority Data
Feb. 21, 2007 (IT) MO2007A000055

(51) Int. Cl. B29C 33/44

(52) U.S. Cl. 425/438

(57) ABSTRACT

A mold device for molding an object having an end wall and a side wall includes a forming core having a lateral forming surface for shaping part of an internal surface of the side wall. The device further includes a forming and disengaging arrangement for shaping a further part of the internal surface and slidably coupled with the forming core to disengage from the further part. It is further provided with an extracting element which is movable with respect to the forming core so as to act on an edge zone of the object for detaching the object from the forming core for extracting the object from the device.

The invention relates to a mould device for forming objects made of plastics, for example caps for containers.

An apparatus is known comprising a punch and a die cooperating together for forming a cap from a dose of plastics. In the die there is obtained a cavity inside which the punch is received so as to define a forming chamber for the cap. The cavity is bounded by a bottom surface surrounded by a cylindrical lateral surface. The bottom surface and the cylindrical lateral surface shape external cap, surfaces.

The punch comprises an external forming surface that shapes an internal surface of the cap. On the external forming surface recesses and ridges are provided that, during forming, generate undercuts arranged inside the cap, for example threads.

The known apparatuses further comprise an extracting sleeve, arranged coaxially around the punch and slidable along the latter, that serves to disengage the cap from the punch once forming has terminated.

During operation, a dose of plastics is introduced inside the die and subsequently the punch and the die are moved towards one another to shape the dose so as to obtain the cap. The external forming surface of the punch cooperates with the bottom surface of the die to shape an end wall of the cap, and with the cylindrical lateral surface of the die to shape a side wall of the cap, having a substantially cylindrical shape.

Once the cap is formed, the punch and the die are moved away from one another, whilst the cap remains associated with the punch as the threads are coupled with the recesses and the ridges of the external forming surface of the punch. At this point the extracting sleeve is driven, which moves slidably with respect to the punch. The extracting sleeve exerts a thrust on an edge zone of the side wall of the cap, so as to force the cap to disengage from the punch. As the cap that has just been formed is still hot and is therefore relatively soft, the threads of the cap are induced to become elastically deformed to disengage from the recesses and the ridges of the punch.

A drawback of the apparatus disclosed above is that the cap can be damaged when it is forced to disengage from the punch. In particular, the undercuts of the cap, for example the threads, may become excessively deformed so as to be damaged. The bigger the undercuts and thus the stiffer the undercuts are, the greater is the risk that they will be damaged whilst the cap is removed from the punch.

An object of the invention is to improve the known apparatuses for forming objects.

A further object is to provide a mould for forming an object, in which the internal surface of the object can be easily detached from the parts of the mould with which it is in contact, without undergoing significant deformation or damage, particularly if the internal surface has undercuts.

According to the invention, there is provided a mould device for moulding an object having an end wall and a side wall, said device comprising a forming core having a lateral forming surface for shaping a part of an internal surface of said side wall, forming and disengaging means for shaping a further part of said internal surface, said forming and disengaging means being slidably coupled with said forming core to disengage from said further part, extracting means for extracting said object from said device, said extracting means being movable with respect to said forming core so as to act on an edge zone of said object for detaching said object from said forming core.

Owing to the invention, it is possible to obtain a mould device per forming an object, which mould device enables the formed object to be removed easily from the forming core, even if the object is devoid of internal undercuts. The mould device is such as to generate limited stress on the object, unlike known apparatuses that deform the object to remove the object from the punch and thus risk damaging the punch irremediably.

In an embodiment, the forming and disengaging means comprises a plurality of forming and disengaging elements, that slide simultaneously with respect to the forming core. The forming and disengaging elements can slide along tilted planes having tilts that are the same as one another with respect to a longitudinal axis of the forming core. In this way, driving of the forming and disengaging elements is significantly simplified, as is also the structure of the mould device.

The mould device can also be used in compression-moulding of objects made of plastics.

The invention can be better understood and implemented with reference to the attached drawings, which illustrate some embodiments thereof by way of non-limiting example, in which:

FIG. 1 is a fragmentary and partially sectioned view of a mould in a first operating configuration;

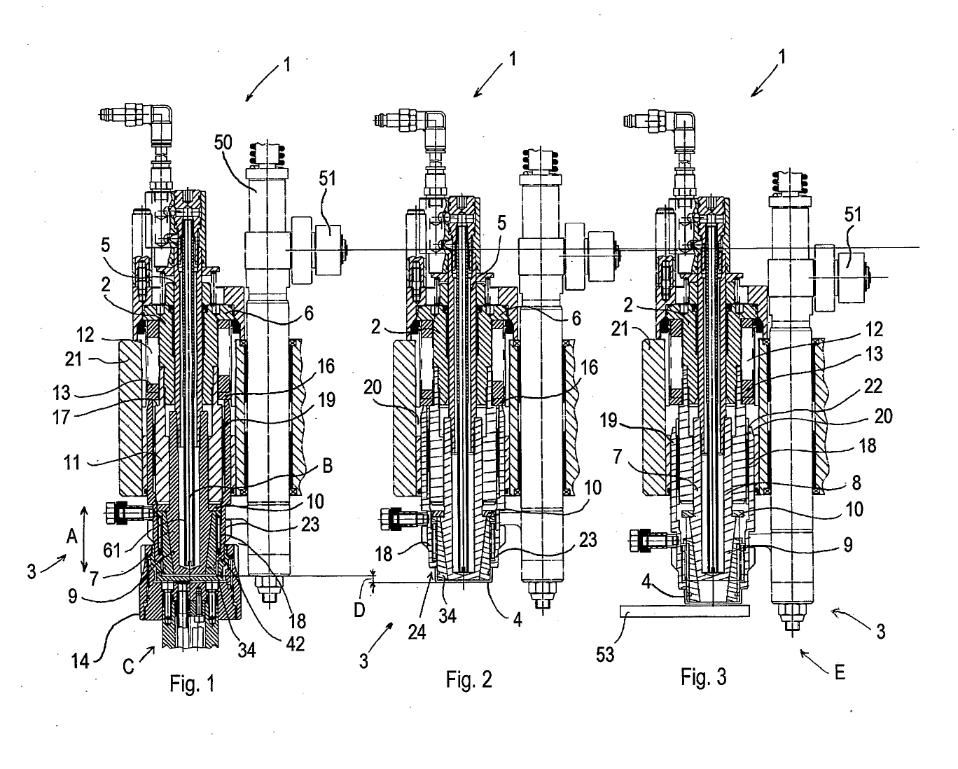

FIG. 2 is a fragmentary and partially sectioned view of the mould in FIG. 1 in a second operating configuration;

FIG. 3 is a fragmentary and partially sectioned view of the mould in FIG. 1 in a third operating configuration;

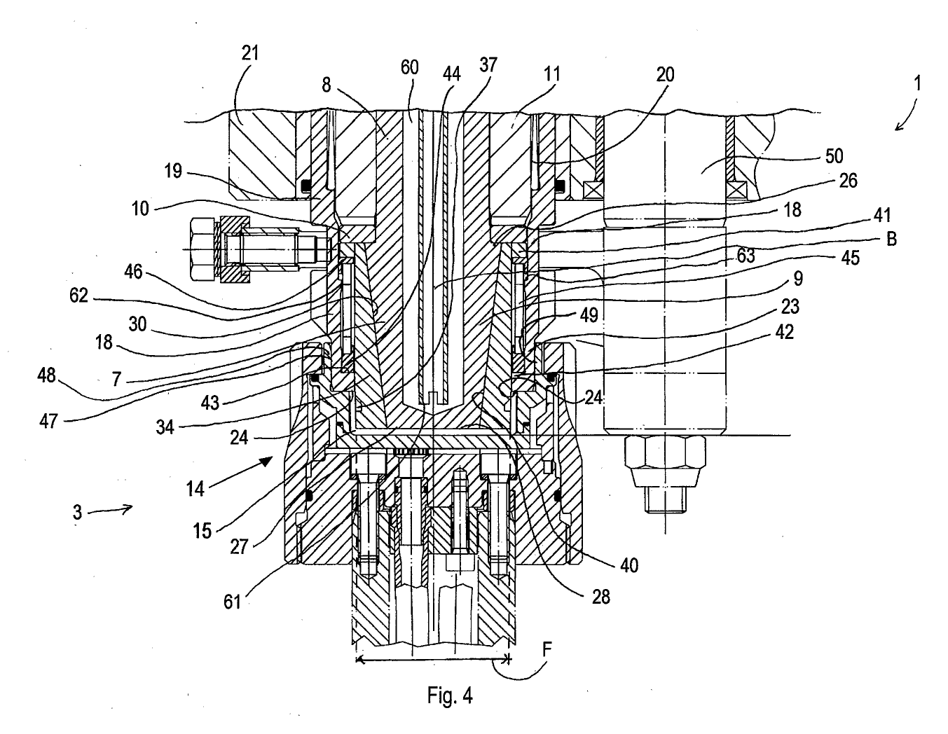

FIG. 4 is an enlarged detail of the mould in the first operating configuration;

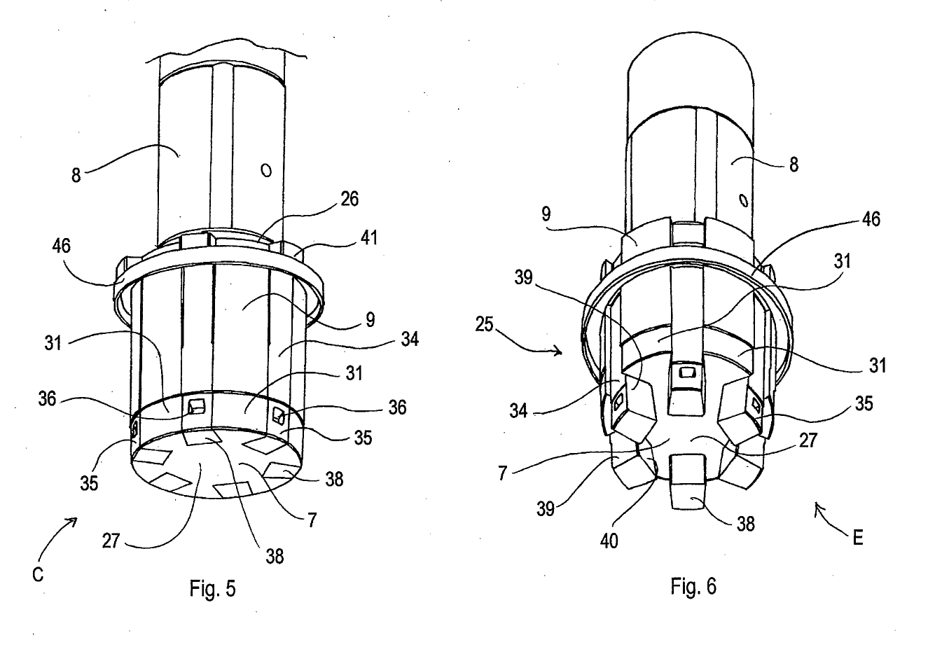

FIG. 5 is a perspective view of a punch included in the mould in FIG. 1, in the first operating configuration;

FIG. 6 is a view like the one in FIG. 5, relating to the third operating configuration;

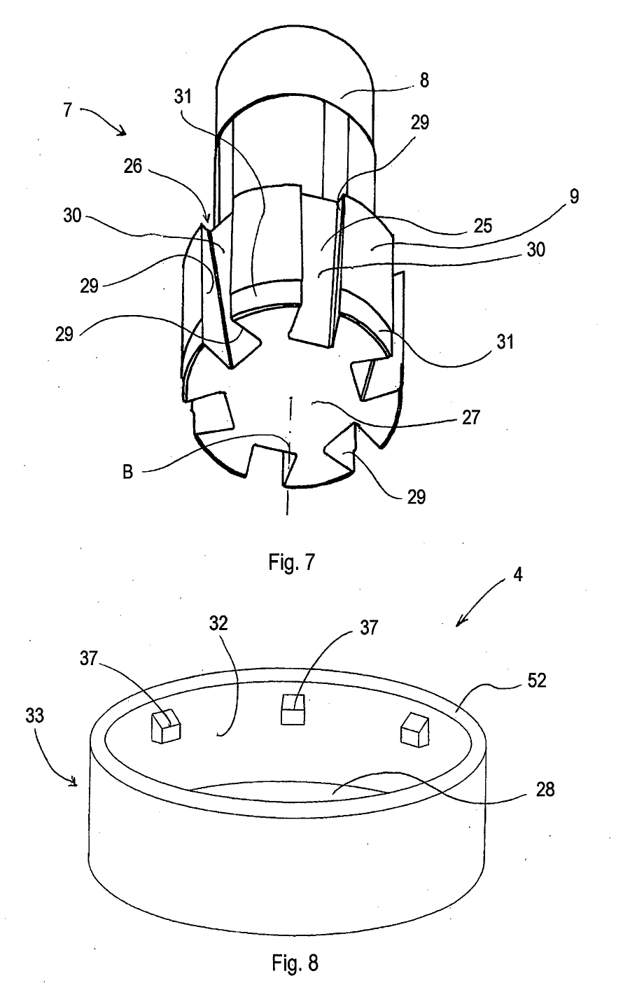

FIG. 7 is a perspective view of a forming core of the mould in FIG. 5;

FIG. 8 shows schematically a cap obtained by the apparatus in FIGS. 1 to 3;

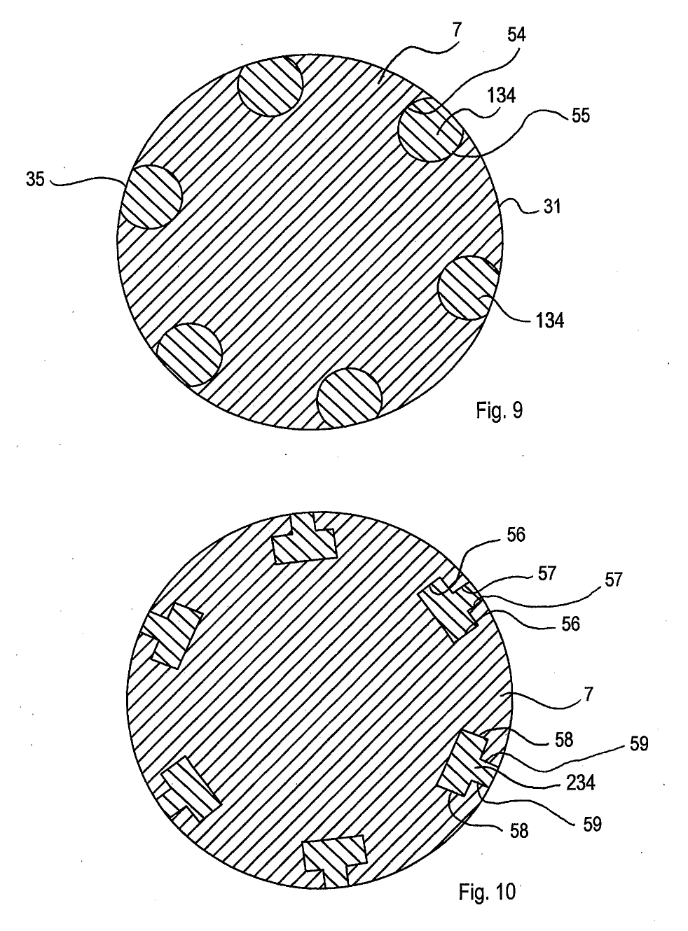

FIG. 9 is a schematic section view of an embodiment of the forming core;

FIG. 10 is a schematic section view of a further embodiment of the forming core.

A mould 1 for compression moulding an object made of plastics, for example a cap 4, comprises a punch 3, suitable for shaping the cap 4 internally, as shown in FIGS. 1 to 4.

The mould 1 further comprises a die 14, shown in FIGS. 1 and 4, provided with a cavity 15 inside which there can be received a dose of plastics from which the cap 4 can be formed.

The punch 3 and the die 14 are movable with respect to one another along a moulding direction A.

In the embodiment shown in FIGS. 1 to 3, the punch 3 is arranged above the die 14.

In an alternative embodiment, the punch can be arranged below the die.

In a further alternative embodiment, the punch and the die may be mutually movable along any direction that is not vertical, for example along a horizontal direction.

The mould 1 can be included in an apparatus comprising a moulding carousel that is not shown that is rotatable around a rotating axis. In a peripheral region of the moulding carousel there is mounted a plurality of moulds like that shown in FIG. 1.

The mould 1 comprises a tubular element 2, which can be fixed to the moulding carousel (not shown). The tubular element 2 is provided above with a flange 6 extending circumferally. A first cylindrical element 5 can slide inside the tubular element 2, along the moulding direction A. A lower part of the first cylindrical element 5 protrudes outside the tubular element 2.

To a lower portion of the first cylindrical element 5 a forming core 7 is connected, included in the punch 3, extending along a longitudinal axis B. The longitudinal axis B is substantially parallel to the moulding direction A. The forming core 7 has a substantially cylindrical first portion 8 and a shaped second portion 9, arranged in a position that is further from the tubular element 2 than the first portion 8. As shown in FIGS. 4 and 7, the second portion 9 comprises a first surface 26 that is substantially annular and near the first portion 8. The second portion 9 comprises a transverse forming surface 27 that is substantially flat and positioned opposite the first surface 26. The transverse forming surface 27 may extend in a substantially continuous manner from the longitudinal axis B to a peripheral region of the second portion 9.

The transverse forming surface 27, during forming, contributes to shaping an end wall 28 of the cap 4 internally.

As shown in FIG. 7, on the second portion 9 there is obtained a plurality of grooves 25 that may be the same as one another. The grooves 25 have a dovetail section and a progressively increasing depth moving from the first surface 26 to the transverse, forming surface 27.

The grooves 25 are distributed uniformly along a peripheral zone of the portion 9, i.e. are angularly equidistant around the longitudinal axis B.

Each groove 25 is bounded by two lateral coupling surfaces that lie on respective planes that converge on one another in a region outside the forming core 7. Each groove 25 is further bounded by a bottom coupling surface 30, tilted with respect to the, longitudinal axis B and interposed between the lateral coupling surfaces 29. The bottom coupling surfaces 30 of all the grooves 25 can be tilted by the same amount with respect to the longitudinal axis B. The bottom coupling surfaces 30 are convergent on the die 14.

Two adjacent grooves 25 are separated by respective first forming surfaces 31, that cooperate with the die 14 for shaping a side wall 33 of the cap 4, shown in FIG. 8. In particular, each forming surface 31 is configured to shape a part of an internal lateral surface 32 of the cap 4.

As shown in FIG. 4, inside the forming core 7 a cooling cavity 60 is obtained into which a cooling conduit 61 leads. The cooling conduit 61 conveys inside the cooling cavity 60 a cooling fluid for cooling the punch 3 and thus the cap 4. The cooling cavity 60 and the forming core 7 are shaped in such a way as to enable correct and rapid stabilisation of the shape of the cap 4 that has just been formed. In particular, near the lower end of the forming core 7 the external diameter F, visible in FIG. 4, of the forming core 7 is substantially equal to the internal diameter of the cap 4. The cooling cavity 60 extends radially so as to be bounded circumferally by wall portions of the punch 3 that are not very thick. In this way, the cooling cavity 60 is separated from the cap 4 by a small distance, and this enables the cooling fluid to remove heat from the cap 4 in a very effective manner.

The punch 3 comprises forming and disengaging means, which both enables the cap 4 to be shaped and enables the cap 4 to be disengaged from the forming core 7. In an embodiment, the forming and disengaging means includes a plurality of forming elements 34, each of which is housed inside a respective groove 25 and is slidably coupled with the latter.

The dovetail joint between the grooves 25 and the forming elements 34 enables the overall dimensions of the punch 3 to be limited and the weight thereof to be contained. In fact, this type of coupling enables the number of pieces to be limited that are required for keeping the forming elements 34 associated with the forming core 7.

The forming elements 34 have a section, taken transversely to the longitudinal axis B, which increases moving to the die 14.

As shown in FIGS. 4 and 6, each forming element 34 is bounded by two further lateral coupling surfaces 39, which may slide along the lateral coupling surfaces 29, and by a tilted coupling surface 40, which may slide along the bottom coupling surface 30.

Each forming element 34 is provided with a second forming surface 35, on which a recess 36 is obtained for forming a projection 37 that projects from the internal lateral surface 32 of the cap 4.

The first forming surfaces 31 and the second forming surfaces 35 cooperate to define the entire internal lateral surface 32 of the cap 4. In particular, the first forming surfaces 31 shape zones of the internal lateral surface 32 that are free of undercuts, whilst the second forming surfaces 35 shape further zones of the internal lateral surface 32 provided with undercuts that can be constituted by the projections 37.

Each forming element 34 is provided with an end-forming surface 38, arranged transversely to the longitudinal axis B and to the second forming surface 35 and positioned below the latter.

The end-forming surfaces 38 cooperate with the transverse forming surface 27 to shape internally the end wall 28 of the cap 4.

Each forming element 34 comprises, at an end thereof that is opposite the end-forming surface 38, a projecting portion 41 that projects in a radial direction and away from the longitudinal axis B.

As shown in FIG. 4, an upper surface of each projecting portion 41 can abut on an annular element 10 that extends around the first portion 8 near the second portion 9. The annular element 10 extends radially with respect to the longitudinal axis B so as to protrude transversely with respect to the second portion 9.

As shown in FIGS. 1 to 4, the first portion 8 is surrounded by a second cylindrical element 11 fixed to the tubular element 2. On the second cylindrical element 11 there is obtained a resting surface 17 arranged transversely to the longitudinal axis B.

The tubular element 2 and the second cylindrical element 11 define a first seat 12 inside which there is housed a first spring 13, shown in FIGS. 1 to 3. An end of the first spring 13 is in contact with a lower surface of the flange 6, and another end of the first spring 13 is in contact with an annular member 16 that can abut on the resting surface 17.

The mould 1 further comprises an extracting element 18, that is coaxial with the longitudinal axis B, to remove the cap 4, once it has been formed, from the punch 3. The extracting element 18, which may be substantially sleeve-shaped, surrounds the forming core 7. The extracting element 18 is movable with respect to the forming core 7 along the moulding direction A. The extracting element 18 has low inertia, which enables the driving thereof to be facilitated and the structure of the mould 1 to be simplified.

The extracting element 18 comprises an upper portion 19, which may have a substantially cylindrical shape, which is slidable inside a seat 20 defined between the second cylindrical element 11 and a supporting element 21 included in the moulding carousel. The upper portion 19 is provided above with an abutting surface 22, arranged transversely to the longitudinal axis B and shown in FIG. 3. The abutting surface 22 can interact with the first spring 13 by means of the annular member 16.

The extracting element 18 comprises a lower portion 23 that is integral with the upper portion 19 and surrounds the second portion 9 of the forming core 7. The lower portion 23 is provided with an annular end 42 which projects towards the longitudinal axis B inside the lower portion 23.

The annular end 42 is bounded below by an operating surface 24, that is used to shape, during forming, an edge zone 52 of the cap 4 and, as will be disclosed below, acts to remove the cap 4 from the mould 1. The operating surface 24 is transverse, for example substantially orthogonal, to the longitudinal axis B.

The lower portion 23 is externally bounded by a cylindrical surface 47, substantially parallel to the longitudinal axis B and suitable for interacting with the die 14.

Inside the extracting element 18 there is mounted a bush 46, having a cross section shaped as an upturned “L”.

Inside the extracting element 18, near the bush 46, there is obtained a protrusion 62, shown in FIG. 4, that projects towards the forming core 7 and is provided with an upper abutting surface 63 suitable for abutting on the bush 46.

The annular end 42 is provided, on the side opposite the operating surface 24, with a contact surface 43 on which there is arranged a ring 44. Between the extracting element 18 and the forming core 7 there is interposed a second spring 45 having great compliance.

A first end of the second spring 45 interacts, by means of the ring 44, with the annular end 42. A second end of the second spring 45 interacts with the bush 46, which in turn is in contact with the projecting portions 41.

In an embodiment, the apparatus 1 may be devoid of the second spring 45. In this case, the forming elements 34 are positioned with respect to the forming core 7 by means of the protrusion 62 which, by interacting with the bush 46, pushes the protruding portions 41 towards the annular element 10.

The extracting element 18 is connected to a driving bar 50, which is movable in the moulding direction A by a roller 51 cooperating with a cam that is not shown, so as to move the extracting element. 18.

As shown in FIG. 4, the die 14 comprises a tubular, wall 48 that surrounds the cavity 15 and is suitable for interacting with the annular end 42. In particular, the tubular wall 48 comprises a further cylindrical surface 49 which, during forming, comes into contact with the cylindrical surface 47. During operation, a dose of plastics is introduced into the cavity 15, whilst the die 14 is spaced away from the punch 3. The die 14 is then driven towards the punch 3, until it reaches a moulding position C, shown in FIG. 1, in which between the die 14 and the punch 3 there is defined a forming chamber having a shape substantially corresponding to the cap 4. Whilst the moulding position C is reached, the die 14 pushes the punch 3 upwards, thus raising the extracting element 18 by a distance D towards the supporting element 21.

In the moulding position C, the extracting element 18 is arranged so that the end-forming surfaces 38 of the forming elements 34 are substantially coplanar with the transverse forming surface 27 of the forming core 7.

The projecting portions 41 of the forming elements 34 are kept abutting on the annular element 10 by the bush 46, on which the second spring 45 acts.

The further cylindrical surface 49 is in contact with the cylindrical surface 47, so that the die 14 is centred on the punch 3.

After the cap 4 has been shaped and the shape thereof has been sufficiently stabilised, the die 14 is moved away from the punch 3. As shown in FIG. 2, the first spring 13 pushes the extracting element 18, the forming elements 34 and the forming core 7 downwards by the distance D.

The cap 4 remains coupled with the forming core 7 as the projections 37 are still engaged in the recesses 36.

The driving bar 50 drives the extracting element 18 moving the extracting element 18 along the longitudinal axis B downwards with respect to the forming core 7, which remains, on the other hand, stationary. The operating surface 24 pushes down the edge zone 52 of the cap 4, so that the end wall 28 of the cap 4 is detached from the forming core 7. Whilst the extracting element 18 moves the cap 4 away from the forming core 7, the projections 37 of the cap 4, engaged in the recesses 36, drag the forming elements 34 towards the die 14. In this manner, the forming elements 34 slide with respect to the forming core 7, so as to protrude with respect to the latter by a progressively increasing amount.

It should be noted that the forming elements 34 move towards the die 14 because they are dragged by the projections 37, which projections 37 are still engaged in the recesses 36. A movement device that slidingly moves the forming elements 34 with respect to the forming core 7 is nevertheless not required. This simplifies the structure of the punch 3 and further ensures that the forming elements 34 do not exert excessive force on the cap 4, but are simply conducted passively by the latter. This enables the stress to be limited that may damage the cap 4.

Owing to the simplified structure and movement of the punch 3, the mould 1 can also be used as a component of complicated apparatuses and be mounted for example on a rotatable moulding carousel of a known apparatus for compression moulding.

By sliding along the grooves 25 towards the die 14, the forming elements 34 approach one another and the longitudinal axis B until they assume an extended position E shown in FIGS. 3 and 6.

As the grooves 25 have a progressively increasing depth towards the die 14 and the bottom coupling surfaces 30 of the forming elements 34 are tilted so as to converge on the longitudinal axis B, the forming elements 34 are moved with a motion component parallel to the longitudinal axis B and a further motion component directed radially towards the longitudinal axis B.

Thus as the forming elements 34 slide towards the die 14, the recesses 36 approach the longitudinal axis B, moving away from the respective projections 37 and disengaging therefrom. The forming elements 34 thus act as forming and disengaging elements that facilitate the removal of the cap 4 from the punch 3.

When the forming elements 34 are in the extended position E, i.e. in an extracting configuration in which the recesses 36 are totally disengaged from the corresponding projections 37, the cap 4 is received in a conveyor 53 that removes the cap 4 definitively from the mould 1.

The driving bar 50 subsequently drives the extracting element 18 towards the supporting element 21 to prepare the extracting element 18 for a new moulding cycle. Whilst the extracting element 18 is moved towards the supporting element 21 by the driving bar 50, the protrusion 62 comes into contact with the bush 46 that acts on the forming elements 34. The extracting element 18, by means of the protrusion 62 and the bush 46, thus moves the forming elements 34 upwards. This enables the end-forming surfaces 38 to be returned to an aligned configuration, in which the end-forming surfaces 38 are flush with the transverse forming surface 27 of the forming core 7.

The second spring 45 acts on the projecting portions 41, so as to recover possible clearance and to ensure that during moulding the forming elements 34 do not protrude from the transverse forming surface 27 of the forming core 7.

The protrusion 62 and the bush 46 thus act as repositioning means for returning the end-forming surfaces 38 to a position aligned on the transverse forming surface 27.

Owing to the repositioning means associated with the extracting element 18, the driving bar 50 enables the extracting element 18 and the forming elements 34 to be moved upwards simultaneously. In this manner, it is possible to avoid using two separate movement systems to move the extracting element 18 and the forming elements 34 upwards.

The grooves 25 can be distributed along a peripheral zone of the first portion 9 also in a non-uniform manner, according to a desired angular distribution. Further, the grooves 25 may have cross sections that are different from one another. The grooves 25 can be configured in such a way that the second forming elements 34 can run along respective planes that are tilted with respect to the longitudinal axis B in a different manner from one another. It is further possible to provide for the second forming elements 34 sliding by respective amounts that are different from one another.

In an alternative embodiment, shown in FIG. 9, the mould comprises a plurality of forming elements 134 having respective cross sections shaped as circle portions. The forming elements 134 are shapingly coupled with respective grooves, each of which is bounded by a curved surface 54. A further curved surface 55 of each forming element 134 slides in contact with the corresponding curved surface 54.

In a further embodiment, the mould comprises a plurality of forming elements 234, each of which has a T-shaped cross section, as shown in FIG. 10. In other words, each forming element 234 has a cross section with parallel sides. The forming elements 234 engage in a shapingly coupled manner with corresponding grooves. Each groove is bounded by a pair of first sides 56 that are parallel to one another and by a pair of second sides 57 that are parallel to one another. The first sides 56 are spaced apart from one another by a first amount, and the second sides 57 are spaced apart from one another by a second amount that is less than the first amount. Each second forming element 234 is bounded by a pair of first faces 58, interacting with the first sides 56, and by a pair of second faces 59, interacting with the second sides 57.

Naturally, also in the embodiments shown in FIGS. 9 and 10, the depth of the grooves in which the forming elements 134 and 234 engage increases approaching the die. In this manner, each forming element 134 or 234 can slide along a plane that is tilted with respect to the longitudinal axis B to free the cap 4.

In the preceding description reference has always been made to a mould for compression moulding a dose of plastics. It is nevertheless possible to use the punch provided with forming and disengaging elements of the type disclosed above for injection-moulding objects made of plastics.

1-39. (canceled)

40. A mold device for molding an object having an end wall and a side wall, said device comprising a forming core having a lateral forming surface for shaping part of an internal surface of said side wall, a forming and disengaging arrangement for shaping a further part of said internal surface, said forming and disengaging arrangement being slidably coupled with said forming core to disengage from said further part, an extracting element for extracting said object from said device, wherein said extracting element is movable with respect to said forming core so as to act on an edge zone of said object for detaching said object from said forming core.

41. A mold device according to claim 40, wherein said forming and disengaging arrangement is movable with respect to said forming core between an extracting configuration, in which said forming and disengaging arrangement projects from said forming core for moving said object away from said forming core, and a forming configuration, in which said forming and disengaging arrangement does not protrude substantially with respect to said forming core.

42. A mold device according to claim 41, wherein said forming and disengaging arrangement is mounted on said forming core so that said object moves said forming and disengaging arrangement from said forming configuration to said extracting configuration, while said object is removed from said forming core.

43. A mold device according to claim 42, wherein said extracting element comprises repositioning elements for moving said forming and disengaging arrangement from said extracting configuration to said forming configuration.

44. A mold device according to claim 43, wherein said repositioning element comprises a protrusion obtained inside said extracting element and protruding towards said forming core.

45. A mold device according to claim 44, wherein said protrusion is bounded by an abutting surface suitable for acting on a projecting portion of said forming and disengaging arrangement for moving said forming and disengaging arrangement to said forming configuration.

46. A mold device according to claim 45, and further comprising a bush element interposed between said abutting surface and said projecting portion.

47. A mold device according to claim 41, and further comprising an elastic element acting on said forming and disengaging arrangement to prevent said forming and disengaging arrangement from protruding from said forming core in said forming configuration.

48. A mold device according to claim 47, and further comprising a bush element interposed between said abutting surface and said projecting portion, wherein said elastic element is interposed between said bush element and an annular end of said extracting element.

49. A mold device according to claim 40, wherein said forming core extends along a longitudinal axis.

50. A mold device according to claim 49, wherein said forming core is bounded by a transverse forming surface arranged transversely to said longitudinal axis for shaping an internal portion of said end wall.

51. A mold device according to claim 50, wherein said transverse forming surface extends in a substantially continuous manner from said longitudinal axis to a peripheral region of said forming core.

52. A mold device according to claim 50, wherein said forming and disengaging arrangement comprises an end-forming surface arranged transversely to said longitudinal axis for shaping a further internal portion of said end wall.

53. A mold device according to claim 52, wherein said forming and disengaging arrangement is movable with respect to said forming core between an extracting configuration, in which said forming and disengaging arrangement projects from said forming core for moving said object away from said forming core, and a forming configuration, in which said forming and disengaging arrangement does not protrude substantially with respect to said forming core and wherein, in said forming configuration, said end-forming surface and said transverse forming surface are substantially coplanar.

54. A mold device according to claim 40, wherein said forming core has a guiding arrangement inside which said forming and disengaging arrangement is slidable, said forming and disengaging arrangement being shapingly coupled with said guiding arrangement.

55. A mold device according to claim 54, wherein said forming core extends along a longitudinal axis and wherein said guiding arrangement is obtained on a surface of said forming core extending along said longitudinal axis.

56. A mold device according to claim 54, wherein said forming core is bounded by a transverse forming surface arranged transversely to said longitudinal axis for shaping an internal portion of said end wall and wherein said guiding arrangement defines a path of said forming and disengaging arrangement, said path progressively approaching said longitudinal axis as said transverse forming surface is approached.

57. A mold device according to claim 56, wherein said guiding arrangement has a depth that increases progressively towards said transverse forming surface.

58. A mold device according to claim 54, wherein said guiding arrangement comprises at least a groove obtained in said forming core.

59. A mold device according to claim 58, wherein said forming core extends along a longitudinal axis and wherein said groove has a cross section that prevents said forming and disengaging arrangement from exiting said groove in a direction that is orthogonal to said longitudinal axis.

60. A mold device according to claim 58, wherein said groove is bounded by tilted lateral coupling surfaces that define with said forming and disengaging arrangement a dovetail coupling.

61. A mold device according to claim 58, wherein said groove has a T-shaped cross section.

62. A mold device according to claim 58, wherein said groove has an incomplete circle cross section.

63. A mold device according to claim 58, wherein said groove is substantially rectilinear.

64. A mold device according to claim 58, wherein said forming core extends along a longitudinal axis and wherein said groove is bounded by a bottom surface tilted with respect to said longitudinal axis.

65. A mold device according to claim 40, wherein said forming and disengaging arrangement is provided with at least a recess to shape an undercut zone of said internal surface.

66. A mold device according to claim 40, wherein said forming and disengaging arrangement comprises a plurality of forming and disengaging elements.

67. A mold device according to claim 66, wherein said forming core extends along a longitudinal axis and wherein the forming and disengaging elements are distributed around said longitudinal axis.

68. A mold device according to claim 67, wherein the forming and disengaging elements are angularly equidistant around said longitudinal axis.

69. A mold device according to claim 40, wherein said extracting element comprises a sleeve that at least partially surrounds said forming core.

70. A mold device according to claim 69, wherein said sleeve comprises an annular operating surface suitable for shaping said edge zone and for pressing on said edge zone for moving said object away from said forming core.

71. A mold device according to claim 40, wherein said forming core contains a cooling cavity for receiving a cooling fluid.

72. A mold device according to claim 71, wherein said forming core has an external diameter that is substantially equal to an internal diameter of said side wall, so that said cooling cavity extends to near said side wall for cooling said object.

73. A mold device according to claim 40, and further comprising a driving bar connected to said extracting element for driving said extracting element.

74. A mold device according to claim 40, wherein said forming core and said forming and disengaging arrangement are included in a punch device.

75. A mold device according to claim 40, wherein said forming core and said forming and disengaging arrangement are included in a compression-molding device for compression-molding a dose of plastics so as to obtain said object.

76. A mold device according to claim 40, wherein said object is a cap.

77. A mold apparatus comprising a plurality of mold devices according to claim 40.

78. A mold apparatus according to claim 77, wherein the mold devices of are mounted in a peripheral region of a rotatable molding carousel.
